(19) United States
(12) Patent Application Publication
(10) Pub. No.: US 2022/0297889 A1
(43) Pub. Date: Sep. 22, 2022

(54) HONEYCOMB PACKAGING

(71) Applicant: MANAVLAR GIDA SANAYIVE TICARET LIMITED SIRKETI, Dalaman, Mugla (TR)

(72) Inventor: Yunus MANAV, Dalaman, Mugla (TR)

(21) Appl. No.: 17/619,984

(22) PCT Filed: Apr. 1, 2021
(86) PCT No.: PCT/TR2021/050301

§ 371 Date: Dec. 16, 2021

(30) Foreign Application Priority Data
Apr. 2, 2020 (TR) 2020/05250

(51) Int. Cl. B65D 25/36; B65D 85/72

(52) U.S. Cl. CPC B65D 25/36; B65D 85/72

(57) ABSTRACT

Disclosed is a packaging for comb honey with its honeycomb that eliminates the bad appearance of the filtered raw honey accumulated on the base of the transparent plastic container used in the packaging and sale of comb honey in the food sector. A feature of the packaging is that the label located at the base of the container extends upwards from all sides of the container to a certain extent.

### TECHNICAL FIELD

The invention relates to the packagings used in the packaging of comb honey in the food industry.

In particular, the invention relates to a comb honey packaging that eliminates the bad appearance of the raw honey accumulated on the bowl floor employing the colored label extending upwards to a certain extent from the bottom of the bowl in which the comb honey is put and packed.

### PRIOR ART

Honey is a natural functional food produced due to the collection of nectars secreted from the flowers or other living parts of plants by honeybees, changing their composition, storing it in honeycomb cells, and ripening.

In the current technique, transparent plastic containers defined as PS or PP are used for the packaging of comb honey. For the sale of comb honey, laths of honeycombs obtained from beekeepers are cut in desired sizes and packaged into containers. The filtered honey, which flows through the pores of honeycombs placed in containers for sale, accumulates on the base of the container; and because it is raw honey, it crystallizes rapidly, causing a bad, unwanted, and undesirable appearance on the base of the container that is not preferred by the customer in the product sales. Although the crystallization in raw honey is a purely physical condition, the end consumer does not want to buy comb honey with this appearance. Therefore, in state of the art, there arises a need for packaging to prevent the adverse opinion of the end consumer in the sale of the comb honey with the honeycombs.

As a result, the existence of the above problems and the inadequacy of existing solutions necessitated an improvement in the relevant technical field.

### THE PURPOSE OF INVENTION

The invention relates to producing a packaging for comb honey to eliminate the disadvantages mentioned above and bring new advantages to the relevant technical field.

The primary purpose of the invention is to offer a comb honey package that eliminates the bad appearance of the raw honey accumulated on the bowl floor employing the colored label extending upwards to a certain extent from the bottom of the bowl in which the comb honey is put and packed.

The purpose of the invention is to cover the unpleasant appearance on the base of the container utilizing a colored dressing label that does not show the inside of the container, in order to prevent the bad image caused by the crystallization of honey on the base of the container without damaging the natural process of honeycomb.

Another purpose of the invention is to eliminate the problem that adversely affects the sale of comb honey with its honeycomb due to the crystallization of raw honey and to ensure that it is preferred by the end consumer.

In order to fulfill all the purposes stated above and that can be derived from the detailed description, the invention is a packaging for the comb honey with its honeycomb that eliminates the bad appearance of the filtered raw honey accumulated on the floor of the transparent plastic container used in the packaging and sale of comb honey in the food sector, wherein;
it comprises a label located at the base of the said container, extending upwards from all sides of the container to a certain extent.

The structural and characteristic features and all advantages of the invention outlined in the drawings below and in the detailed description made by referring these figures will be understood clearly. Therefore, the evaluation should be made considering these figures and detailed explanations.

### BRIEF DESCRIPTION OF THE FIGURES

FIG. 1: It is the perspective view of the comb honey package of the invention.

FIG. 2: It is the perspective view of the comb honey package of the invention from the bottom.

### REFERENCE NUMBERS

10. Container
20. Lid
30. Label
31. Gap

### DETAILED DESCRIPTION OF THE INVENTION

In this detailed description, preferred embodiments of the comb honey packaging of the invention will be explained only for a better understanding of the subject matter and without any restrictive effect.

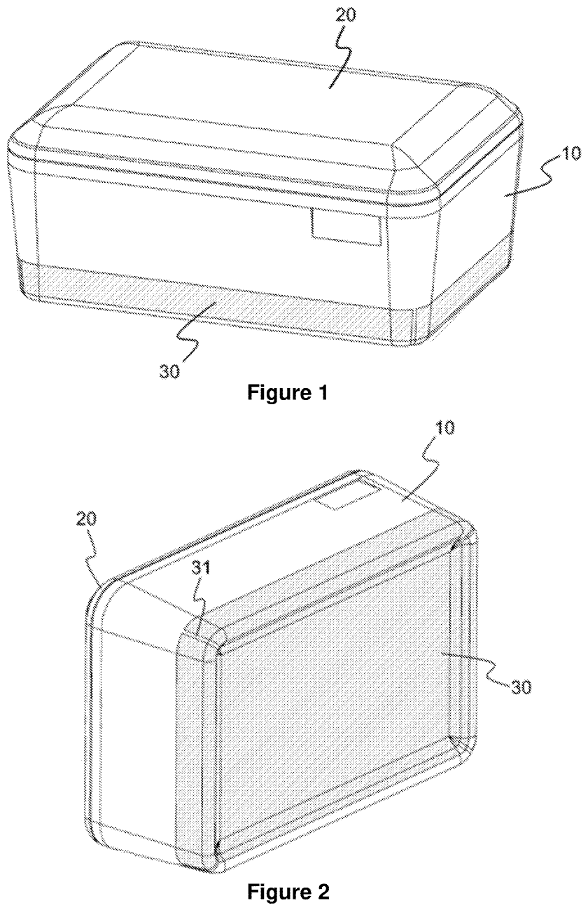

FIGS. 1 and 2 show the perspective views of comb honey packaging of the invention. Accordingly, the comb honey package in its most basic form comprises a transparent plastic container (10) in the form of a rectangular prism on which the lid (20) is closed, and a colored label (30) extending upwards to a certain extent from the base of the container (10).

The container (10) is rectangular in shape and transparent plastic, forming the main structure of the comb honey packaging of the invention. The lid (20) was closed on the container (10) so that it could be used for the packaging and sale of the comb honey.

At the bottom of the container (10), there is a label (30) that extends upwards from all sides to a certain extent. The label (30) is colored and is made unified with the container (10) through the in-mold labeling (IML) method. There is a gap (31) between the junction points of the label (30) corresponding to the corners of the container (10).

In the in-mold labeling (IML) method, the label (30) is placed in the mold before the container (10) is produced, and the container (10) and the label (30) are combined into a whole-body during the plastic injection.

The part of the label (30) that extends upwards from the edges of the container (10) is colored, and the base surface may be opaque white.

Since the label (30) has a structure extending from the base of the container (10) upwards from all sides and is colored, it is ensured that the crystallized part of the comb honey that flows to the base inside the container (10) and shows the container (10) dirty is covered.

1. A packaging for comb honey with its honeycomb that eliminates the bad appearance of the filtered raw honey accumulated on the base of the transparent plastic container used in the packaging and sale of comb honey in the food sector, the packaging comprising:
a label located at a base of the container extending upwards from all sides of the container to a certain extent.

2. The package for the comb honey with honeycombs according to claim 1, wherein the part of the said label that extends upwards from the edges of the container is colored.

3. The package for the comb honey with honeycombs according to claim 1, wherein the part of the said label that covers the bottom is opaque white.

4. The package for the comb honey with honeycombs according to claim 1, wherein the label is made unified with the container through an in-mold labeling (IML) method.
